(19) United States
(12) Patent Application Publication
(10) Pub. No.: US 2017/0191816 A9
(43) Pub. Date: Jul. 6, 2017

(54) Wheel Alignment Toe Stand-off

(71) Applicant: Nicholas Ross Tenhulzen, San Jose, CA (US)

(72) Inventor: Nicholas Ross Tenhulzen, San Jose, CA (US)

(73) Assignee: Nicholas Ross Tenhulzen, San Jose, CA (US)

(21) Appl. No.: 14/833,074

(22) Filed: Aug. 22, 2015

Related U.S. Application Data
(60) Provisional application No. 61/998,228, filed on Jun. 23, 2014.

(51) Int. Cl. G01B 5/255; G01B 3/10

(52) U.S. Cl. CPC G01B 5/255; G01B 3/1084; G01B 2210/10; G01B 2003/1092

(57) ABSTRACT

This invention improves the process of using automotive wheel alignment toe plates to perform wheel alignment by measuring from the wheel of the vehicle instead of the tire as is standard with toe plates measurement. The result of this new invention is the elimination of the tire as a source of error.

### BACKGROUND OF THE INVENTION

This invention is designed to improve a method of wheel alignment, specifically a tool which commonly referred to in the industry as a “Toe Plate”. The definition of toe plate is an apparatus which contacts the working surface at 2 or more points, as well as the vehicle wheel/tire assembly at 2 or more points, and has provisions for 2 tape measures to be used, one on each side of the axle.

A diagram of the process of using toe plates is illustrated in FIG. 1. When measurements are to be taken using this method, a vehicle to be measured, two toe plates, and two tape measures are required.

Toe Plate process:
1. One plate is placed on each side of one vehicle axle near the outside sidewall.
2. Two or more points of the toe plate must contact the working surface (the working surface is usually but not exclusively the ground).
3. Two or more points of the toe plate must contact the wheel/tire assembly.
4. Two tape measures must be used, with one on each side of the axle, to measure the distance between the two sides of the toe plates. The result will be the toe measurement of the axle, as measured using the toe plate process.

A downfall of this method, is accuracy issues that can arise from the toe plate leaning against the tire and create error. This can be caused by a variety of causes included but not limited to tire flex and lettering on the sidewall of the tire. This may change the angle of the toe plate thus the measurement can be affected.

### BRIEF SUMMARY OF THE INVENTION

A source of error of the toe plate vehicle alignment measuring process is the toe plates resting against the vehicle tire. The invention eliminates the tire as a source of error by contacting the wheel directly.

### BRIEF DESCRIPTION DRAWINGS

FIG. 1 demonstrates the standard toe plates process, as conducted without the invention. One toe plate is against each tire. One tape measure is used on each side, each extending from one toe plate to the other. The most notable attribute of this drawing is the demonstration of the toe plates against the tire, as is standard process without the invention.

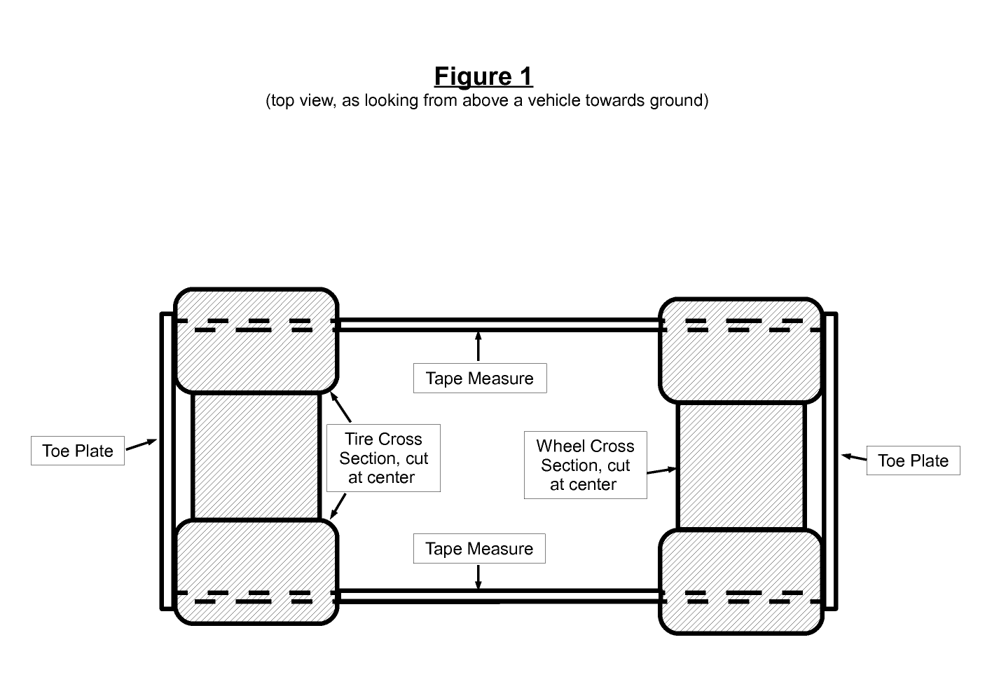

FIG. 2 demonstrates the toe plates process, as conducted with the invention. As depicted, the invention allows the toe plates to reference the wheel, instead of the tire. As shown. tape measures are used in the same fashion as without the invention.

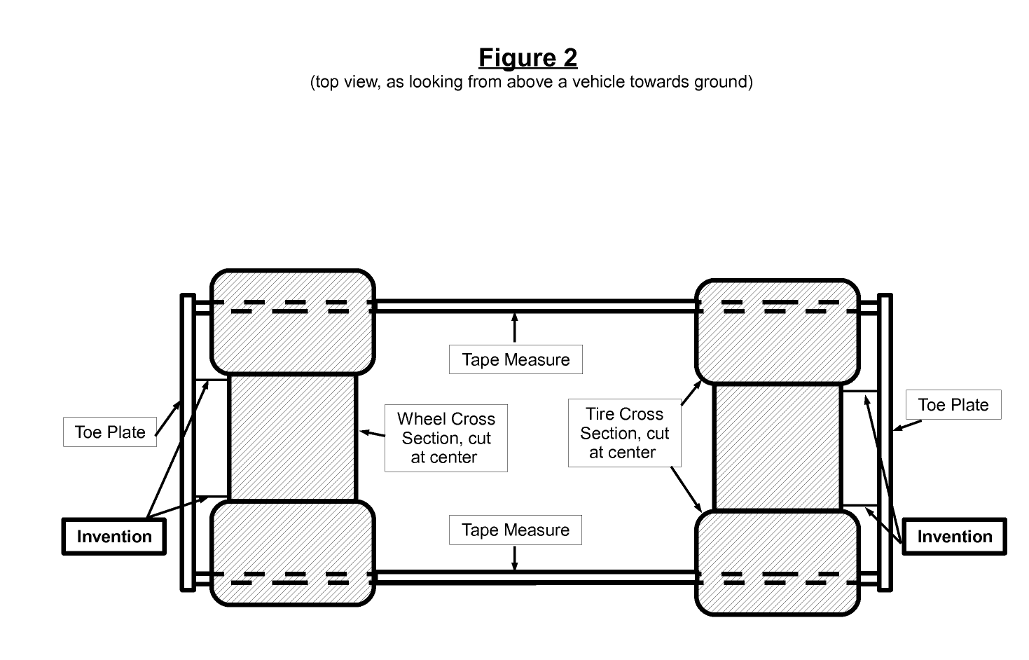

FIG. 3 Alternate view of process with invention, again demonstrating invention contacting wheel.

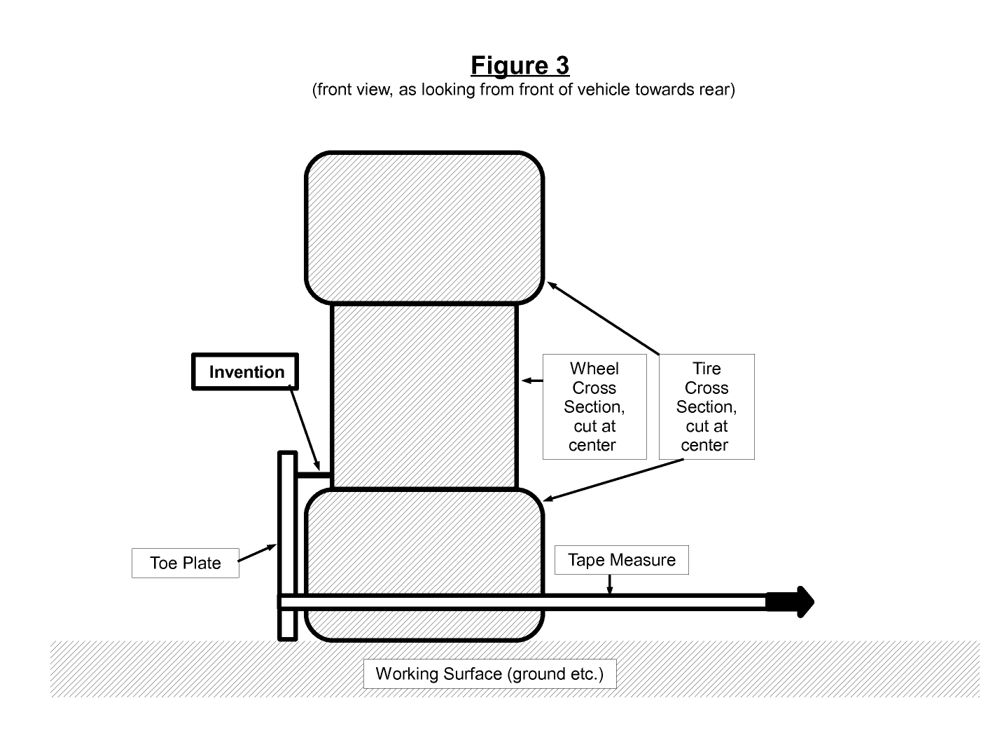

FIG. 4 is to demonstrate the side view of the toe plate process. What is notable in this figure is the toe plate contacting the working surface at 2 or more points.

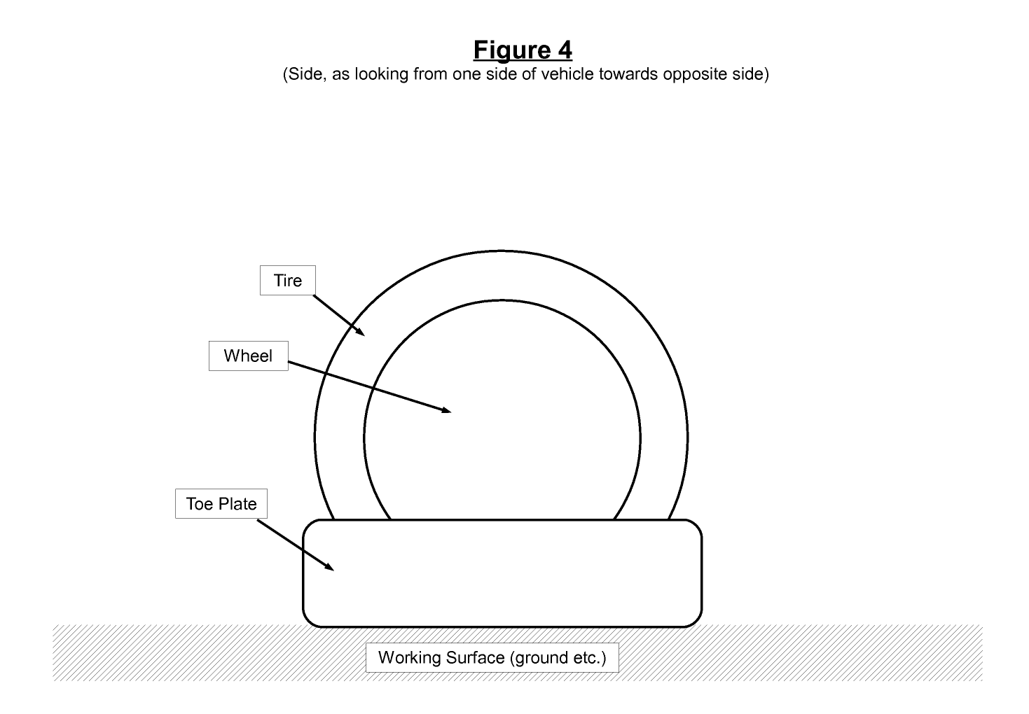

### DETAILED DESCRIPTION OF THE INVENTION

The invention combines with what is in the automotive alignments industry referred to as “toe plates”. It creates a more accurate measurement than existing methods of this style of measurement, because instead of using a tire as the point of measurement, the invention contacts the wheel directly.

To add the invention to toe plates, the invention can either be adjustable or fixed, and must be able to contact the wheel of the vehicle being measured at 2 or more points. The invention should be ridged as to not flex or bend during use. The invention must be raised off the surface of the toe plates so then when placed against a wheel/tire assembly the invention touches the wheel, rather than the toe plate touching the tire. The invention should be constructed such that when placed on said wheel tire assembly, the toe plate will be parallel with the wheel in the toe direction (toe is a common industry term, and is the angle of the wheel when viewed from the top). The invention could be constructed using items including but not limited to stand-offs, pins, or bolts, on the toe plate.

Once the invention is fitted, the toe plates and invention can then be used in the same process as standard toe plates, but with the invention contacting the wheel, instead of the toe plate contacting the tire.

1. An apparatus that combines with an automotive wheel alignment toe plate to increase the accuracy of vehicle wheel alignment by contacting the wheel of a vehicle at two or more points, thus using the wheel as the point of measurement.
